(19) United States
(12) Patent Application Publication
(10) Pub. No.: US 2013/0224495 A1
(43) Pub. Date: Aug. 29, 2013

(54) LED CURING OF RADIATION CURABLE FLOOR COATINGS

(71) Applicants: Keqi Gan, Geneva, IL (US); Timothy Bishop, Algonquin, IL (US); Tai-Yeon Lee, Crystal Lake, IL (US); Huimin Cao, Addison, IL (US); Mark Diaz, Tustin, CA (US)

(72) Inventors: Keqi Gan, Geneva, IL (US); Timothy Bishop, Algonquin, IL (US); Tai-Yeon Lee, Crystal Lake, IL (US); Huimin Cao, Addison, IL (US); Mark Diaz, Tustin, CA (US)

(21) Appl. No.: 13/514,391

(22) PCT Filed: Dec. 16, 2010
(86) PCT No.: PCT/US10/60647

§ 371 Date: Nov. 6, 2012

Related U.S. Application Data
(60) Provisional application No. 61/287,600, filed on Dec. 17, 2009.

(51) Int. Cl. C09D 7/12

(52) U.S. Cl. CPC C09D 7/1233
USPC 428/413; 428/423.1; 428/523; 428/480; 427/513; 522/152; 522/63; 522/64; 522/55; 522/53

(57) ABSTRACT

A radiation curable coating for a floor comprising: at least one radiation curable oligomer, at least one photoinitiator and at least one reactive diluent monomer, said radiation curable oligomer being selected from the group consisting of Urethane (meth)acrylates, epoxy (meth)acrylates, polyester (meth)acrylates, acrylic (meth)acrylates, and hydrocarbon (meth)acrylates is described and claimed. The composition is capable of undergoing photopolymerization when coated on a floor and when irradiated by a light emitting diode (LED) light, having a wavelength from about 100 nm to about 900 nm, to provide a cured coating on the floor, with the cured coating having an external surface, and the cured coating having a Percent Reacted Acrylate Unsaturation (% RAU) at the external surface of about 60% or greater. Also described and claimed are the process to coat a floor with the LED curable coating for floor and a coated floor where the coating has been cured by application of LED light.

### CROSS-REFERENCE TO RELATED PATENT APPLICATION

This patent application claims priority to U.S. Provisional Patent Application No. 61/287,600, filed on Dec. 17, 2009, which is incorporated by reference in its entirety.

### FIELD OF THE INVENTION

The present invention relates to radiation curable coatings for floors and methods of formulating these compositions.

### BACKGROUND OF THE INVENTION

Radiation Curable Coatings for Concrete Floors are commercially available from DSM Desotech Inc. as follows:

UVolve® Instant Floor Coatings from DSM Desotech Inc., 1122 St, Charles Street, Elgin, Ill. 60120, 847-697-0400. UVolve® Instant Floor Coatings are high performance, instant cure coating systems for concrete floors. They are available in both clear and pigmented systems and cure instantly with the use of a UV light machine specifically designed for use with UVolve® Instant Floor Coatings. UVolve® radiation curable coatings for concrete floors have the following features and benefits: their virtually instant curing ability allows for immediate traffic—even forklift. They are one-component systems: no mixing, no pot life constraints or wasted product. The cured coating protects concrete against damage from dirt, wear and chemicals. Cured UVolve® Instant Floor Coatings clean easily—especially forklift tire marks. The use of radiation curable coatings for concrete floors means that the facility maintenance costs will be lower due to easy clean. UVolve® Instant Floor Coatings have Zero VOC, no solvents, and 100% solids. UVolve® Instant Floor Coatings cure to a high gloss, durable finish which exhibits excellent scratch and impact resistance. See: http://www.uvolvecoatings.com/

UV curable concrete coatings are further discussed in the article, “UV Curable Concrete Coatings” by Jo Ann Arceneaux, Ph.D., Cytec Industries Inc., Smyrna, Ga., presented at the Federation of Societies for Coatings Technology, “Coatings for Concrete Conference: “Coating the World of Concrete”, on Feb. 2, 2009 at the Westin Casuarina Las Vegas Hotel in Las Vegas, Nev. and in the article, “Field-Applied, UV-Curable Coatings for Concrete Flooring”, by Peter T. Weissman, published in the January/February/March 2009 RADTECH Report.

UV curable coatings for wood are commercially available and are described and discussed in the article, “Wood Finishing with UV-Curable Coatings” by Lawrence C. Van Iseghem, ©2006, pp. 32-38, RADTECH REPORT, May/June 2006, and in the article: “Field Applied UV Cured Topcoats for Wood” by Jo Ann Arceneaux, Ph.D., Cytec Industries Inc., Smyrna, Ga., first presented at UV.EB East Oct. 20-21, 2009, at the Conference Center at Niagara Falls, N.Y. (now posted on the CYTEC website with the following internet address: http://www.cytec.com/innovation/pdf/ConferencePresentations/200909_ArceneauxJ_Topcoats.pdf)

The use of ultraviolet mercury arc lamps to emit ultraviolet light suitable to cure radiation curable coatings applied to various substrates is well known. Ultraviolet arc lamps emit light by using an electric arc to excite mercury that is resided inside an inert gas (e.g., Argon) environment to generate ultraviolet light which effectuates curing. Alternatively, microwave energy can also be used to excite mercury lamp in an inert gas medium to generate the ultraviolet light. For easy identification purpose, the arc excited and microwave excited mercury lamps, plus various additives (Ferrous metal, Gallium, etc) modified forms of these mercury lamps, are identified as mercury lamps in general in this application

However, the use of ultraviolet mercury lamps as a radiation source suffers from several disadvantages including environmental concerns from mercury and the generation of ozone as a by-product. Further, mercury lamps typically have lower energy conversion ratio, require warm-up time, generate heat during operation, and consume a large amount of energy when comparing with LED.

Light emitting diodes (LEDs) are semiconductor devices which use the phenomenon of electroluminescence to generate light. LEDs consist of a semiconducting material doped with impurities to create a p-n junction capable of emitting light as positive holes join with negative electrons when voltage is applied. The wavelength of emitted light is determined by the materials used in the active region of the semiconductor. Typical materials used in semiconductors of LEDs include, for example, elements from Groups 13 (III) and 15 (V) of the periodic table. These semiconductors are referred to as III-V semiconductors and include, for example, GaAs, GaP, GaAsP, AlGaAs, InGaAsP, AlGaInP, and InGaN semiconductors. Other examples of semiconductors used in LEDs include compounds from Group 14 (IV-IV semiconductor) and Group 12-16 (II-VI). The choice of materials is based on multiple factors including desired wavelength of emission, performance parameters, and cost.

Early LEDs used gallium arsenide (GaAs) to emit infrared (IR) radiation and low intensity red light. Advances in materials science have led to the development of LEDs capable of emitting light with higher intensity and shorter wavelengths, including other colors of visible light and UV light. It is possible to create LEDs that emit light anywhere from a low of about 100 nm to a high of about 900 nm. Currently, known LED UV light sources emit light at wavelengths between about 300 and about 475 nm, with 365 nm, 390 nm and 395 nm being common peak spectral outputs. See textbook, “Light-Emitting Diodes” by E. Fred Schubert, 2^{nd} Edition, © E. Fred Schubert 2006, published by Cambridge University Press.

LED lamps offer advantages over mercury lamps in curing applications. For example, LED lamps do not use mercury gas to generate light and are typically less bulky than mercury UV arc lamps. In addition, LED lamps are instant on/off sources requiring no warm-up time, which contributes to LED lamps' low energy consumption. LED lamps also generate less heat, have longer lamp lifetimes, and are essentially monochromatic emitting a desired wavelength of light which is governed by the choice of semiconductor materials employed in the LED.

It is anticipated that there will be a transition period for the introduction of LED lamps into the concrete and wood floor coating industry. During this period, they may be used in conjunction with conventional mercury lamps, rather than completely replacing them.

Several manufacturers offer LED lamps for commercial curing applications. For example, Phoseon Technology, Summit UV, Honle UV America, Inc., IST Metz GmbH, Jenton International Ltd., Lumios Solutions Ltd., Solid UV Inc., Seoul Optodevice Co., Ltd, Spectronics Corporation, Luminus Devices Inc., and Clearstone Technologies, are some of the manufacturers currently offering LED lamps for curing ink jet printing compositions, PVC floor coatings, metal coatings, plastic coating, and adhesive compositions.

There are known UV curing applications for dental work, where there are existing LED curing devices available. An example of a known curing device for dental work is the Elipar™ FreeLight 2 LED curing light from 3M ESPE. This device emits light in the visible region with a peak irradiance at 460 nm.

Current radiation curable floor coatings are not suitable for curing by LED lamps because heretofore these compositions have been formulated to be cured by mercury arc lights which produce a different spectral output, namely a spectral output over several wavelengths. Though currently available “conventionally curing” UV curable coatings for floors may actually begin to cure when exposed to light from an LED light source, the cure speed is so slow the coating would not cure fast enough to be commercially viable. The final cured films' properties would also not be able to meet the performance requirements due to the current formulation deficiencies. Therefore, it is not practical to use currently available LED lamps to cure currently available radiation curable coatings for floors.

PCT Published Patent Application WO 2005/103121, entitled “Method for photocuring of Resin Compositions”, assigned to DSM IP Assets B.V., describes and claims Methods for Light Emitting Diode (LED) curing of a curable resin composition containing a photoinitiating system, characterized in that the highest wavelength at which absorption maximum of the photoinitiating system occurs (λ_{Max PIS}) is at least 20 nm below, and at most 100 nm below, the wavelength at which the emission maximum of the LED occurs (λ_{LED}). The invention in this PCT patent application relates to the use of LED curing in structural applications, in particular in applications for the lining or relining of objects, and to objects containing a cured resin composition obtained by LED curing. This invention provides a simple, environmentally safe and readily controllable method for (re)lining pipes, tanks and vessels, especially for such pipes and equipment having a large diameter, in particular more than 15 cm.

The foregoing shows that there is an unmet need to provide radiation curable floor coatings which are suitable for curing by LED light, to provide processes for coating floors with such coatings, and to provide coated floors comprising coatings prepared from such coatings.

### SUMMARY OF THE INVENTION

The first aspect of the instant claimed invention is a radiation curable floor coating composition, wherein the composition is capable of undergoing photopolymerization when coated on the surface of a floor and when cured by irradiating with light emitted from a light emitting diode (LED) light having a wavelength from 100 nm to 900 nm, to provide a cured coating on the surface of the floor, said cured coating having a surface, said cured coating having a % Reacted Acrylate Unsaturation (% RAU) of about 60% or greater as measured at said surface, preferably from 90% to 99%.

The second aspect of the instant claimed invention The radiation curable floor coating composition of the first aspect of the instant claimed invention, wherein the light emitting diode (LED) emits light with a wavelength of

from 100 nm to 300 nm;

from 300 nm to 475 nm; or

from 475 nm to 900 nm.

The third aspect of the instant claimed invention is a radiation curable floor coating composition of the first or second aspect of the instant claimed invention comprising:
(a) at least one radiation curable oligomer selected from the group consisting of urethane (meth)acrylates, epoxy (meth)acrylates, polyester (meth)acrylates, acrylic (meth)acrylates, and hydrocarbon (meth)acrylates;
(b) at least one reactive diluent monomer; and
(c) at least one photoinitiator.

The fourth aspect of the instant claimed invention is a radiation curable floor coating composition of the third aspect of the instant claimed invention wherein the photoinitiator is a Type I photoinitiator, preferably selected from the group consisting of 2-benzyl-2-(dimethylamino)-4′-morpholinobutyrophenone, bis(2,4,6-trimethylbenzoyl)-phenylphosphineoxide, 2,4,6-trimethylbenzoyl diphenylphosphineoxide, 2-methyl-4′-(methylthio)-2-morpholinopropiophenone, and any combination thereof.

The fifth aspect of the instant claimed invention is a radiation curable floor coating composition of the third aspect of the instant claimed invention, wherein the photoinitiator is a Type II photoinitiator and the composition includes a photosensitizer, the photoinitiator preferably being selected from the group consisting of 4-benzoyl-4′-methyl-diphenylsulfide and 2-isopropyl thioxanthone and any combination thereof.

The sixth aspect of the instant claimed invention is a radiation curable floor coating composition of any one of the first through fifth aspects of the instant claimed invention, in which at least 15% of the ingredients in the coating are biobased, rather than petroleum based, preferably at least 20% of the ingredients, more preferably at least 25% of the ingredients.

The seventh aspect of the instant claimed invention is a radiation curable floor coating composition of any one of the first through sixth aspects of the instant claimed invention, wherein the at least one oligomer is a urethane acrylate oligomer.

The eighth aspect of the instant claimed invention is a process for coating a floor comprising:
(a) selecting a floor to be coated;
(b) preparing the surface of said floor to be coated;
(c) coating said floor with at least one radiation curable coating composition for a floor, preferably a radiation curable floor coating composition according to any one of the first through seventh aspects of the instant claimed invention, wherein said at least one radiation curable floor coating comprises:
   (i) at least one radiation curable oligomer selected from the group consisting of urethane (meth)acrylates, epoxy (meth)acrylates, polyester (meth)acrylates, acrylic (meth)acrylates, and hydrocarbon (meth)acrylates;
   (ii) at least one reactive diluent monomer; and
   (iii) at least one photoinitiator;
   to obtain a coated floor with an uncured coating, and
(d) curing said uncured coating on said coated glass optical fiber by irradiating said uncured coating with a light emitting diode (LED) light, having a wavelength from 100 nm to 900 nm, to obtain a cured coating having a surface, said cured coating having a % Reacted Acrylate Unsaturation (% RAU) at the surface of about 60% or greater, preferably from 90% to 99%.

The ninth aspect of the instant claimed invention is a process according to the eighth aspect of the instant claimed inventions, wherein said floor is selected from the group of concrete floors and wood floors.

The tenth aspect of the instant claimed invention is a process of any one of the eighth or ninth aspects of the instant claimed invention, wherein the wavelength of the light emitted from the LED that is used to cure the radiation curable coating is

from 100 nm to 300 nm;

from 300 nm to 475 nm; or

from 475 nm to 900 nm.

The eleventh aspect of the instant claimed invention is a process of any one of claims 8-10, wherein the at least one oligomer is a urethane acrylate oligomer;

The twelfth aspect of the instant claimed invention is a coated floor obtainable by the process of any one of the eighth through eleventh aspects of the instant claimed invention.

The thirteenth aspect of the instant claimed invention is a coated floor of the twelfth aspect of the instant claimed invention wherein the photoinitiator present in the radiation curable floor coating composition is a Type I photoinitiator, preferably selected from the group consisting of 2-benzyl-2-(dimethylamino)-4′-morpholinobutyrophenone, bis(2,4,6-trimethylbenzoyl)-phenylphosphineoxide, 2,4,6-trimethylbenzoyl diphenylphosphineoxide, 2-methyl-4′-(methylthio)-2-morpholinopropiophenone, and any combination thereof.

The fourteenth aspect of the instant claimed invention is a coated floor of the twelfth aspect of the instant claimed invention, wherein the photoinitiator is a Type II photoinitiator and the composition includes a photosensitizer, the photoinitiator preferably being selected from the group consisting of 4-benzoyl-4′-methyl-diphenylsulfide and 2-isopropyl thioxanthone and any combination thereof.

The fifteenth aspect of the instant claimed invention is a radiation curable floor coating comprising:
(a) at least one radiation curable oligomer;
(b) at least one reactive diluent monomer; and
(c) at least one photoinitiator;

wherein said radiation curable oligomer is selected from the group consisting of Urethane (meth)acrylates, epoxy (meth)acrylates, polyester (meth)acrylates, acrylic (meth)acrylates, and hydrocarbon (meth)acrylates;

wherein the composition is capable of undergoing photopolymerization when coated on the surface of a floor and when cured by irradiating with light emitted from a light emitting diode (LED) light having a wavelength from about 100 nm to about 900 nm, to provide a cured coating on the surface of the floor, said cured coating having a surface, said cured coating having a % Reacted Acrylate Unsaturation (% RAU) of about 60% or greater as measured at said surface.

The sixteenth aspect of the instant claimed invention is a coated floor comprising a floor and at least one coating, wherein said at least one coating is produced by coating the surface of said floor with at least one radiation curable floor coating comprising:
(a) at least one radiation curable oligomer;
(b) at least one reactive diluent monomer; and
(c) at least one photoinitiator;

wherein said radiation curable oligomer is selected from the group consisting of Urethane (meth)acrylates, epoxy (meth)acrylates, polyester (meth)acrylates, acrylic (meth)acrylates, and hydrocarbon (meth)acrylates;

to obtain an uncured coated surface, and then curing said uncured coated surface of a floor by irradiating said radiation curable coating with light emitted from a light emitting diode (LED) light having a wavelength from about 100 nm to about 900 nm, to obtain a cured coating having a surface, wherein the cured coating has a % Reacted Acrylate Unsaturation (% RAU) of about 60% or greater as measured at said surface.

The seventeenth aspect of the instant claimed invention is a process for coating a floor comprising:
(a) selecting a floor to be coated with the radiation curable floor coating composition of the instant claimed invention, wherein said floor is selected from the group of concrete floors and wood floors;
(b) preparing the surface of said floor to be coated;
(c) coating said floor with at least one radiation curable coating for a floor, wherein said at least one radiation curable floor coating comprising:
(i) at least one radiation curable oligomer;
(ii) at least one reactive diluent monomer; and
(iii) at least one photoinitiator;

wherein said radiation curable oligomer is selected from the group consisting of Urethane (meth)acrylates, epoxy (meth)acrylates, polyester (meth)acrylates, acrylic (meth)acrylates, and hydrocarbon (meth)acrylates;

to obtain a coated floor with an uncured coating, and
(d) curing said uncured coating on said coated glass optical fiber by irradiating said uncured coating with a light emitting diode (LED) light, having a wavelength from about 100 nm to about 900 nm, to obtain a cured coating having a surface, said cured coating having a % Reacted Acrylate Unsaturation (% RAU) at the surface of about 60% or greater.

The eighteenth aspect of the instant claimed invention is a floor coating of the fifteenth aspect of the instant claimed invention, wherein the floor the coating is applied to is selected from the group consisting of concrete and wood floors.

The nineteenth aspect of the instant claimed invention is a floor coating of the fifteenth aspect of the instant claimed invention, wherein the cured coating has a % RAU of from about 90% to about 99%.

The twentieth aspect of the instant claimed invention is a floor coating of the fifteenth aspect of the instant claimed invention, wherein the light emitting diode (LED) emits light with a wavelength from about 100 nm to about 300 nm.

The twenty-first aspect of the instant claimed invention is a floor coating of the fifteenth aspect of the instant claimed invention, wherein the light emitting diode (LED) emits light with a wavelength from about 300 nm to about 475 nm.

The twenty-second aspect of the instant claimed invention is a floor coating of the fifteenth aspect of the instant claimed invention, wherein the light emitting diode (LED) emits light with a wavelength from about 475 nm to about 900 nm.

The twenty-third aspect of the instant claimed invention is a floor coating of the fifteenth aspect of the instant claimed invention, wherein the photoinitiator is a Type I photoinitiator.

The twenty-fourth aspect of the instant claimed invention is a floor coating of the fifteenth aspect of the instant claimed invention, wherein the photoinitiator is a Type II photoinitiator and the composition includes a photosensitizer.

The twenty-fifth aspect of the instant claimed invention is a floor coating of the eighteenth aspect of the instant claimed invention wherein the floor the coating is applied to is a concrete floor.

The twenty-sixth aspect of the instant claimed invention is a floor coating of the eighteenth aspect of the instant claimed invention, wherein the floor the coating is applied to is a wood floor.

The twenty-seventh aspect of the instant claimed invention is a radiation curable floor coating of the fifteenth aspect of the instant claimed invention, in which at least about 15% of the ingredients in the coating are bio-based, rather than petroleum based.

The twenty-eighth aspect of the instant claimed invention is a radiation curable floor coating of the twenty-fourth aspect of the instant claimed invention, in which at least about 20% of the ingredients in the composition are bio-based, rather than petroleum based.

The twenty-ninth aspect of the instant claimed invention is a radiation curable floor coating of the twenty-fifth aspect of the instant claimed invention, in which at least about 25% of the ingredients in the composition are bio-based, rather than petroleum based.

The thirtieth aspect of the instant claimed invention is a coated floor of the sixteenth aspect of the instant claimed invention, wherein the coated floor is selected from the group consisting of concrete and wood floors.

The thirty-first aspect of the instant claimed invention is a coated floor of the sixteenth aspect of the instant claimed invention, wherein the cured coating has a % RAU of from about 90% to about 99%.

The thirty-second aspect of the instant claimed invention is a coated floor of the sixteenth aspect of the instant claimed invention, wherein the photoinitiator present in the radiation curable coating is a Type I photoinitiator.

The thirty-third aspect of the instant claimed invention is a coated floor of the sixteenth aspect of the instant claimed invention, wherein the photoinitiator is selected from the group consisting of 2-benzyl-2-(dimethylamino)-4′-morpholinobutyrophenone, bis(2,4,6-trimethylbenzoyl)-phenylphosphineoxide, 2,4,6-trimethylbenzoyl diphenylphosphineoxide, 2-methyl-4′-(methylthio)-2-morpholinopropiophenone, and any combination thereof.

The thirty-fourth aspect of the instant claimed invention is a coated floor of the sixteenth aspect of the instant claimed invention, wherein the photoinitiator is a Type II photoinitiator and the composition includes a hydrogen donor.

The thirty-fifth aspect of the instant claimed invention is a coated floor of the sixteenth aspect of the instant claimed invention, wherein the photoinitiator is selected from the group consisting of 4-benzoyl-4′-methyl-diphenylsulfide and 2-isopropyl thioxanthone and any combination thereof.

The thirty-sixth aspect of the instant claimed invention is a process of the seventeenth aspect of the instant claimed invention, wherein the at least one oligomer is a urethane acrylate oligomer.

The thirty-seventh aspect of the instant claimed invention is a process of the seventeenth aspect of the instant claimed invention, wherein the wavelength of the light emitted from the LED that is used to cure the radiation curable coating is from about 100 nm to about 300 nm.

The thirty-eighth aspect of the instant claimed invention is a process of the seventeenth aspect of the instant claimed invention, wherein the wavelength of the light emitted from the LED that is used to cure the radiation curable coating is from about 300 nm to about 475 nm.

The thirty-ninth aspect of the instant claimed invention is a process of the seventeenth aspect of the instant claimed invention, wherein the wavelength of the light emitted from the LED that is used to cure the radiation curable coating is from about 475 nm to about 900 nm.

### DETAILED DESCRIPTION OF THE INVENTION

Throughout this patent application the following terms have the indicated meanings:

UVA radiation is radiation with a wavelength between about 320 and about 400 nm.

UVB radiation is radiation with a wavelength between about 280 and about 320 nm.

UVC radiation is radiation with a wavelength between about 100 and about 280 nm.

As used herein, the term “renewable resource material” is defined as a starting material that is not derived from petroleum but as a starting material derived from a plant including the fruits, nuts and/or seeds of plants. These plant derived materials are environmentally friendly and biologically based materials. Thus, these starting materials are also frequently called “bio-based” materials or “natural oil” materials.

Further to the understood definition of “bio-based”, according to the FRSIA (Farm Security and Rural Investment Act), “biobased products” are products determined by the U.S. Secretary of Agriculture to be “commercial or industrial goods (other than food or feed) composed in whole or in significant part of biological products, forestry materials, or renewable domestic agricultural materials, including plant, animal or marine materials.

Biobased content may be determined by testing to ASTM Method D6866-10, STANDARD TEST METHODS FOR DETERMINING THE BIOBASED CONTENT OF SOLID, LIQUID, AND GASEOUS SAMPLES USING RADIOCARBON ANALYSIS. This method, similar to radiocarbon dating, compares how much of a decaying carbon isotope remains in a sample to how much would be in the same sample if it were made of entirely recently grown materials. The percentage is called the product's biobased content.

Persons of ordinary skill in the art of radiation curable coatings are aware of how to select ingredients and understand whether the ingredient is bio-based or petroleum based. What is different now is the sheer abundance of bio-based raw materials suitable for use in radiation curable coatings. For example, bio-based raw materials can be found in polyols and other ingredients.

Radiation Curable Coatings for Floors are described in the following

### REFERENCES

DSM Desotech website wherein UVolve® Instant Floor Coatings are described and offered for sale: http://www.uvolvecoatings.com/

“UV Curable Concrete Coatings” by Jo Ann Arceneaux, Ph.D., Cytec Industries Inc., Smyrna, Ga., presented at the Federation of Societies for Coatings Technology, “Coatings for Concrete Conference: “Coating the World of Concrete”, on Feb. 2, 2009 at the Westin Casuarina Las Vegas Hotel in Las Vegas, Nev.

“Field-Applied, UV-Curable Coatings for Concrete Flooring”, by Peter T. Weissman, published in the January/February/March 2009 RADTECH Report, which are incorporated by reference, in their entirety.

The fifteenth aspect of the instant claimed invention is a radiation curable floor coating comprising:
(a) at least one radiation curable oligomer;
(b) at least one reactive diluent monomer; and
(c) at least one photoinitiator;

wherein said radiation curable oligomer is selected from the group consisting of Urethane (meth)acrylates, epoxy (meth)acrylates, polyester (meth)acrylates, acrylic (meth)acrylates, and hydrocarbon (meth)acrylates;

wherein the composition is capable of undergoing photopolymerization when coated on the surface of a floor and when cured by irradiating with light emitted from a light emitting diode (LED) light having a wavelength from about 100 nm to about 900 nm, to provide a cured coating on the surface of the floor, said cured coating having a surface, said cured coating having a % Reacted Acrylate Unsaturation (% RAU) of about 60% or greater as measured at said surface.

Urethane (meth)acrylates, epoxy (meth)acrylates, polyester (meth)acrylates, acrylic (meth)acrylates, and hydrocarbon (meth)acrylates oligomers are well known in the art of radiation curable coatings for many substrates, including concrete and wood coatings. See pages 3-101 of the reference text, MODERN COATING TECHNOLOGY, Edited by J. C. Colbert, copyright 1982 by Noyes Data Corporation, editor: J. C. Colbert for discussions of these oligomers.

Urethane (meth)acrylate oligomers are based on stoichiometric combinations of di-isocyanates (DICs), polyols and some type of hydroxy-functional terminating species containing a UV-reactive terminus. Depending on the properties desired, different types of polyols are chosen. These polyols include, but are not limited to, polyether-polypropylene glycols (PPG) and polyether-polytetramethylene glycols (PTMG).

Petroleum-derived components such as polyester and polyether polyols pose several disadvantages. Use of such polyester or polyether polyols contributes to the depletion of petroleum-derived oil, which is a non-renewable resource. Also, the production of a polyol requires the investment of a great deal of energy because the oil needed to make the polyol must be drilled, extracted and transported to a refinery where it is refined and processed to purified hydrocarbons that are subsequently converted to alkoxides and finally to the finished polyols. As the consuming public becomes increasingly aware of the environmental impact of this production chain, consumer demand for “greener” products will continue to grow. To help reduce the depletion of petroleum-derived oil whilst satisfying this increasing consumer demand, it would be advantageous to partially or wholly replace petroleum-derived polyester or polyether polyols used in the production of urethane (meth)acrylate oligomers with renewable and more environmentally responsible components.

US Published Patent Application 20090275674A1 describes and claims “UV/EB Curable BioBased Coating For Flooring Application”. Claim 1 in this published patent application reads as follows: “1. A radiation curable biobased coating comprising a biobased resin, a biobased polyol acrylate, or a biobased polyol, the biobased component being blended with a coating formula, the coating formula including at least one initiator, wherein the radiation curable biobased coating contains at least about 5% by weight of renewable materials or biobased content.” Claim 18 in this published patent application reads as follows: “18. A flooring application, comprising:

A substrate having at least one surface provided with a radiation curable biobased coating; and
the radiation curable biobased coating comprising a biobased component, the biobased component being selected from the group consisting of a biobased resin, a biobased polyol acrylate, or a biobased polyol, the biobased component being blended with a coating formula, the coating formula including at least one initiator, wherein the radiation curable biobased coatings contains at least about 5% weight of renewable materials or biobased content.” This published US Patent Application is incorporated by reference, in its entirety.

The article, “Floor Coating Formulations Obtained from 100% Natural, Renewable or Biobased Materials”, was submitted for publication at e/5: UV & EB Technology Expo & Conference 2008, May 5-8, 2008 Chicago Ill. The authors are Dong Tian, Keith T. Quisenberry, Mary Kate Boggiano, Larry W. Leininger, Susan L. Scheuering and Jeffrey S. Ross and they worked for Armstrong World Industries, Inc. of Lancaster Pa. The abstract for this article reads as follows: A variety of raw materials are used in so-called “greener” coating systems. This paper summarizes what this means for several “green” categories, and how to use these items to formulate floor coatings. Materials covered include: seed, nut, grass and softwood products; biofuel waste; modified small molecules; materials from enzyme catalyzed reactions; and renewable inorganic fillers. Also reviewed are selected commercially available “green” coating systems for flooring. Finally, performance of selected model systems is reported.

With careful selection of the ingredients chosen to synthesize the oligomer and the coating made with the oligomer it is possible to synthesize radiation curable coatings for coating floors wherein at least about 15% of the ingredients in the coating are bio-based, rather than petroleum based

In an embodiment, the radiation curable floor coating composition of the instant claimed invention is such that at least about 15% of the ingredients in the coating are bio-based, rather than petroleum based.

In an embodiment, the radiation curable floor coating composition of the instant claimed invention is such that at least about 20% of the ingredients in the coating are bio-based, rather than petroleum based.

In an embodiment, the radiation curable floor coating composition of the instant claimed invention is such that at least about 25% of the ingredients in the coating are bio-based, rather than petroleum based.

Photoinitiators and Stabilizers are also described in this reference text on pages 29-34.

Reactive Diluent Monomers are well known in the art of radiation curable coatings for optical fiber and many of the Reactive Diluent Monomers that are present in radiation curable coatings for optical fiber are also used in radiation curable coatings for concrete and wood floors. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of reactive diluent monomers.

The compositions of the present invention include a free radical photoinitiator as Urethane (meth)acrylates, epoxy (meth)acrylates, polyester (meth)acrylates, acrylic (meth)acrylates, and hydrocarbon (meth)acrylates oligomers all require a free radical photoinitiator. In general, free radical photoinitiators are well known in the art of radiation curable coatings. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of photoinitiators. For further descriptions of reactive diluent monomers suitable for use in the instant claimed invention please see the U.S. patents, previously listed in this document and previously incorporated by reference.

Typically, free radical photoinitiators are divided into those that form radicals by cleavage, known as “Norrish Type I” and those that form radicals by hydrogen abstraction, known as “Norrish type II”.

To successfully formulate a radiation curable coatings for concrete and wood floors, it is necessary to review the wavelength sensitivity of the photoinitiator(s) present in the coating to determine if they will be activated by the LED light chosen to provide the curing light.

For LED light sources emitting in the 300-475 nm wavelength range, especially those emitting at 365 nm, 390 nm, or 395 nm, examples of suitable photoinitiators absorbing in this area include: benzoylphosphine oxides, such as, for example, 2,4,6-trimethylbenzoyl diphenylphosphine oxide (Lucirin TPO from BASF) and 2,4,6-trimethylbenzoyl phenyl, ethoxy phosphine oxide (Lucirin TPO-L from BASF), bis(2,4,6-trimethylbenzoyl)-phenylphosphineoxide (Irgacure 819 or BAPO from Ciba), 2-methyl-1-[4-(methylthio)phenyl]-2-morpholinopropanone-1 (Irgacure 907 from Ciba), 2-benzyl-2-(dimethylamino)-1-[4-(4-morpholinyl) phenyl]-1-butanone (Irgacure 369 from Ciba), 2-dimethylamino-2-(4-methyl-benzyl)-1-(4-morpholin-4-yl-phenyl)-butan-1-one (Irgacure 379 from Ciba), 4-benzoyl-4′-methyl diphenyl sulphide (Chivacure BMS from Chitec), 4,4′-bis(diethylamino)benzophenone (Chivacure EMK from Chitec), and 4,4′-bis(N,N′-dimethylamino)benzophenone (Michler's ketone). Also suitable are mixtures thereof.

Additionally, photosensitizers are useful in conjunction with photoinitiators in effecting cure with LED light sources emitting in this wavelength range. Examples of suitable photosensitizers include: anthraquinones, such as 2-methylanthraquinone, 2-ethylanthraquinone, 2-tertbutylanthraquinone, 1-chloroanthraquinone, and 2-amylanthraquinone, thioxanthones and xanthones, such as isopropyl thioxanthone, 2-chlorothioxanthone, 2,4-diethylthioxanthone, and 1-chloro-4-propoxythioxanthone, methyl benzoyl formate (Darocur MBF from Ciba), methyl-2-benzoyl benzoate (Chivacure OMB from Chitec), 4-benzoyl-4′-methyl diphenyl sulphide (Chivacure BMS from Chitec), 4,4′-bis(diethylamino)benzophenone (Chivacure EMK from Chitec).

It is possible for LED UV light sources to be designed to emit light at shorter wavelengths. For LED light sources emitting at wavelengths from between about 100 and about 300 nm, it is desirable to employ a photosensitizer with a photoinitiator. When photosensitizers, such as those previously listed are present in the formulation, other photoinitiators absorbing at shorter wavelengths can be used. Examples of such photoinitiators include: benzophenones, such as benzophenone, 4-methyl benzophenone, 2,4,6-trimethyl benzophenone, and dimethoxybenzophenone, and, 1-hydroxyphenyl ketones, such as 1-hydroxycyclohexyl phenyl ketone, phenyl (1-hydroxyisopropyl)ketone, 2-hydroxy-1-[4-(2-hroxyethoxy)phenyl]-2-methyl-1-propanone, and 4-isopropylphenyl(1-hydroxyisopropyl)ketone, benzil dimethyl ketal, and oligo-[2-hydroxy-2-methyl-1-[4-(1-methylvinyl)phenyl]propanone] (Esacure KIP 150 from Lamberti).

LED light sources can also be designed to emit visible light, which can also be used to cure optical fiber coatings, inks, buffers, and matrix materials. For LED light sources emitting light at wavelengths from about 475 nm to about 900 nm, examples of suitable photoinitiators include: camphorquinone, 4,4′-bis(diethylamino)benzophenone (Chivacure EMK from Chitec), 4,4′-bis(N,N′-dimethylamino)benzophenone (Michler's ketone), bis(2,4,6-trimethylbenzoyl)-phenylphosphineoxide (Irgacure 819 or BAPO from Ciba), metallocenes such as bis(eta 5-2-4-cyclopentadien-1-yl)bis[2,6-difluoro-3-(1H-pyrrol-1-yl)phenyl]titanium (Irgacure 784 from Ciba), and the visible light photoinitiators from Spectra Group Limited, Inc. such as H-Nu 470, H-Nu-535, H-Nu-635, H-Nu-Blue-640, and H-Nu-Blue-660.

In one embodiment of the instant claimed invention, the light emitted by the LED is UVA radiation, which is radiation with a wavelength between about 320 and about 400 nm.

In one embodiment of the instant claimed invention, the light emitted by the LED is UVB radiation, which is radiation with a wavelength between about 280 and about 320 nm.

In one embodiment of the instant claimed invention, the light emitted by the LED is UVC radiation, which is radiation with a wavelength between about 100 and about 280 nm.

In one embodiment of the instant claimed invention, the present composition comprises, relative to the total weight of the composition, from about 0.5 wt % to about 7 wt % of one or more free radical photoinitiators. In one embodiment, the present composition comprises, relative to the total weight of the composition, from about 1 wt % to about 6 wt % of one or more free radical photoinitiators, relative to the total weight of the composition. In another embodiment, the present composition comprises, relative to the total weight of the composition, from about 2 wt % to about 5 wt % of one or more free radical photoinitiators.

Normally, cationic photoinitiators are not required or desired in urethane (meth)acrylate oligomer based radiation curable coatings to function as photoinitiators.

The measurement of the amount of curing a radiation curable urethane (meth)acrylate based coating has undergone is typically done by conducting a “Percent Reacted Acrylate Unsaturation” (abbreviate “% RAU”) determination. For the coatings of the instant claimed invention, upon curing with an LED light having a wavelength of from about 100 nm to about 900 nm, the % RAU at the surface of the coating is about 60% or greater, preferably about 70% or greater, more preferably about 75% or greater, more highly preferably about 80% or greater, most preferably about 85% or greater, most highly preferably about 90% or greater, and highest preferably from about 90% to about 99%. It is possible to achieve a % RAU of 100% using LED's to cure the compositions of the instant claimed invention.

The sixteenth aspect of the instant claimed invention is a coated floor comprising a floor and at least one coating, wherein said at least one coating is produced by coating the surface of said floor with at least one radiation curable floor coating comprising:
(a) at least one radiation curable oligomer;
(b) at least one reactive diluent monomer; and
(c) at least one photoinitiator;

wherein said radiation curable oligomer is selected from the group consisting of Urethane (meth)acrylates, epoxy (meth)acrylates, polyester (meth)acrylates, acrylic (meth)acrylates, and hydrocarbon (meth)acrylates;

to obtain an uncured coated surface, and then

curing said uncured coated surface of a floor by irradiating said radiation curable coating with light emitted from a light emitting diode (LED) light having a wavelength from about 100 nm to about 900 nm, to obtain a cured coating having a surface, wherein the cured coating has a % Reacted Acrylate Unsaturation (% RAU) of about 60% or greater as measured at said surface.

Any concrete or wood floor may be coated with radiation curable coatings successfully providing the floor presents a solid, intact surface and prior to application of the coating, the floor is swept clean and otherwise prepared for the application of the coating.

The seventeenth aspect of the instant claimed invention is a process for coating a floor comprising:
(a) selecting a floor to be coated with the radiation curable floor coating composition of the instant claimed invention, wherein said floor is selected from the group of concrete floors and wood floors;
(b) preparing the surface of said floor to be coated;
(c) coating said floor with at least one radiation curable coating for a floor, wherein said at least one radiation curable coating comprises:
   (i) at least one radiation curable oligomer;
   (ii) at least one reactive diluent monomer; and
   (iii) at least one photoinitiator;

wherein said radiation curable oligomer is selected from the group consisting of Urethane (meth)acrylates, epoxy (meth)acrylates, polyester (meth)acrylates, acrylic (meth)acrylates, and hydrocarbon (meth)acrylates;

to obtain a coated floor with an uncured coating, and
(d) curing said uncured coating on said coated glass optical fiber by irradiating said uncured coating with a light emitting diode (LED) light, having a wavelength from about 100 nm to about 900 nm, to obtain a cured coating having a surface, said cured coating having a % Reacted Acrylate Unsaturation (% RAU) at the surface of about 60% or greater.

In coating a floor with a radiation curable coating, the first step in the process is selecting the floor to be coated. Any concrete or wood floor may be coated with radiation curable coatings successfully providing the floor presents a solid, intact surface and prior to application of the coating, the floor is swept clean and otherwise prepared for the application of the coating. It is known in the art of installing and coating concrete and wood floors how to sweep the floor and otherwise prepare it for coating. For example, in the art of coating concrete floors with radiation curable coatings is known to require that the surface of the concrete floor be scraped clean of any other coating or marking present and then the scraped floor must be swept clean of any debris left over from the cleaning.

After the floor has been selected and cleaned in preparation for coating, it should be observed for its structural integrity in that successful application of radiation curable coatings typically requires that the floor be an intact, solid surface with no major cracks or other defects. Once an intact, solid, cleaned floor surface is available for coating, the coating may be applied by any coating method that is known in the art such as by brushing, spraying or rolling. After the coating is applied, the liquid coating is cured into a solid coating by application of light of the correct wavelength, wherein the light is generated by a Light Emitting Diode.

LED's are commercially available. Suppliers of commercially available LED's have been previously listed in this document.

The specific examples herein disclosed are to be considered as being primarily illustrative. Various changes beyond those described, will, no doubt, occur to those skilled in the art; and such changes are to be understood as forming a part of this invention insofar as they fall within the spirit and scope of the appended claims.

### EXAMPLES

The present invention is further illustrated with a number of examples, which should not be regarded as limiting the scope of the present invention.

Test Method for Percent Reacted Acrylate Unsaturation for the Surface of the Floor Coating {abbreviated as % RAU Primary Test Method}:

Degree of cure on the Surface of the Floor Coating is determined by FTIR using a diamond ATR accessory. FTIR instrument parameters include: 100 co-added scans, 4 cm⁻¹ resolution, DTGS detector, a spectrum range of 4000-650 cm⁻¹, and an approximately 25% reduction in the default mirror velocity to improve signal-to-noise.

Two spectra are required; one of the uncured liquid Floor Coating and one that corresponds to the Surface of the Floor Coating. The spectrum of the liquid Primary coating is obtained after completely covering the diamond surface with the coating. The liquid should be the same batch that is used to coat the fiber or wire if possible, but the minimum requirement is that it must be the same formulation. The final format of the spectrum should be in absorbance.

To obtain a spectra of the Surface of the Floor Coating, a sample of liquid Floor Coating has been applied to a floor and then cured using the specified LED light, a razor is used to cut a ¾ by ¾ inch square of the floor coating, which is then carefully removed using tweezers. The sample is mounted on a 1-inch square piece of 3-mil Mylar film by using a thin film of contact cement to secure the ¾ by ¾ inch square of the floor coating to the Mylar film.

The exposed cured Floor Coating on the Mylar film is mounted on the center of the diamond with one axis aligned parallel to the direction of the infrared beam. Pressure should be put on the back of the sample to insure good contact with the crystal. The resulting spectrum should not contain any absorbances from the contact cement. If contact cement peaks are observed, a fresh sample should be prepared. It is important to run the spectrum immediately after sample preparation rather than preparing any multiple samples and running spectra when all the sample preparations are complete. The final format of the spectrum should be in absorbance.

For both the liquid Floor Coating and the cured Floor coating, measure the peak area of both the acrylate double bond peak at 810 cm⁻¹ and a reference peak in the 750-780 cm⁻¹ region. Peak area is determined using the baseline technique where a baseline is chosen to be tangent to absorbance minima on either side of the peak. The area under the peak and above the baseline is then determined. The integration limits for the liquid and the cured sample are not identical but are similar, especially for the reference peak.

The ratio of the acrylate peak area to the reference peak area is determined for both the liquid and the cured sample. Degree of cure, expressed as percent reacted acrylate unsaturation (% RAU), is calculated from the equation below:

$$\% RAU = \frac{( {R}_{L} - {R}_{F} ) \times 100}{{R}_{L}}$$

where R_{L} is the area ratio of the liquid Floor Coating sample and R_{F} is the area ratio of the cured Floor Coating.

The components listed in these Examples have the following commercial names, are available from the listed source and have the indicated chemical composition.

TABLE 1
Description of Components Used in the Examples

| Name of | | CAS Registry | |
|---|---|---|---|
| Component | Chemical Description | Number | Supplier |
| SR 508 | dipropylene glycol | 57472-68-1 | Sartomer |
| | diacrylate monomer | | |
| EB P115 | copolymerizable amine | Proprietary | Cytec |
| EB 891 | Polyester Acrylate | Proprietary | Cytec |
| EB 81 | amine modified | proprietary | Cytec |
| | polyester acrylate | | |
| CN 549 | Acrylic Oligomer | Proprietary | Sartomer |
| Darocure 1173 | 2-hydroxy-2-methyl-1- | 7473-98-5 | |
| | phenyl-1-propanone | | |
| | photoinitiator | | |
| Irgacure 184 | 1-hydorxy | 947-19-3 | BASF |
| | cyclohexylphenyl ketone | | |
| | photoinitiator | | |
| Irgacure 819 | bis(2,4,6- | 162881-26-7 | BASF |
| | trimethylbenzoy1)- | | |
| | phenylphosphineoxide | | |
| | photoinitiator | | |
| SR 355 | Di-trimethylopropane | 57472-68-1 | Sartomer |
| | tetraacrylate | | |
| SR 9003 | Propoxylated₂Neopentyl | 57472-68-1 | Sartomer |
| | glycol diacrylate | | |
| TPO | 2,4,6-trimethylbenzoyl | 75980-60-8 | BASF |
| | diphenylphosphine oxide | | |
| | photoinitiator | | |
| Camphorquinone | Bornane 2,3 Dione | 10373-78-1. | Garuda |
| | | | Chemicals |
| | | | or Esstech |
| Black pigment | V818 | Proprietary | DSM |
| dispersion | | | Desotech |

### Example A

### Reformulating Concrete Floor Coatings for Cure Using LED

| | | Comparative example of |
|---|---|---|
| | | floor coating formulation |
| | | cured by medium |
| | Example of the invention- | pressure Mercury Arc |
| | LED curable example | LED light |
| EB 891 | 30 | 32 |
| EB 81 | 15 | 5 |
| SR 355 | 15 | 20 |
| SR 508 | 15 | 14.8 |
| SR 9003 | 14 | 25 |
| Darocure | 2.25 | 1.35 |
| 1173 | | |
| Irgacure | 2.25 | 1.35 |
| 184 | | |
| Irgacure | 1.5 | |
| 819 | | |
| TPO | | 0.5 |
| EB P115 | 5 | |
| Total | 100 | 100 |

The following LED lamp with settings listed is used for concrete coating.
Model: Phoseon 75x50WC 395, RX FireFlex, water cooling LED, S/N: 585001
Speed: 27 ft/min
LED output: By EIT Power Puck, S/N: 2692. UVB=UVC=0. UVA=0.499 w/cm² and 0.136 J/cm². The measurement for UVV was saturation with current Power Puck UVV>5.000 w/cm² and >01.584 J/cm².

### Example B

### Reformulating Concrete Floor Coatings for Cure Using LED

For a pigmented coating system.

| | Example of the |
|---|---|
| | invention-LED curable |
| | example |
| Ingredient | Weight % |
| EB 891 | 30 |
| CN 549 | 15 |
| SR 355 | 13 |
| SR 508 | 15 |
| SR 9003 | 14 |
| Darocure 1173 | 2 |
| lrgacure 184 | 2 |
| Irgacure 819 | 1.5 |
| EB P115 | 5 |
| Black pigment dispersion | 0.25 |
| White pigment dispersion | 2.25 |
| Total | 100 |

The following LED lamp with settings listed is used for concrete coating.
Model: Phoseon 75x50WC 395, RX FireFlex, water cooling LED, S/N: 585001
Speed: 27 ft/min
LED output: By EIT Power Puck, S/N: 2692. UVB=UVC=0. UVA=0.499 w/cm² and 0.136 J/cm². The measurement for UVV was saturation with current Power Puck UVV>5.000 w/cm² and >01.584 J/cm².

### Example C

Reformulating Concrete Floor Coatings for Cure using LED, a clear coating system.

| | Example of the |
|---|---|
| | invention-LED curable |
| | example |
| Ingredient | Weight % |
| EB 891 | 30 |
| EB 81 | 15 |
| SR 355 | 15 |
| SR 508 | 15 |
| SR 9003 | 14 |
| Darocure 1173 | 2 |
| Irgacure 184 | 2 |
| Irgacure 819 | 0.5 |
| EBP115 | 5 |
| Camphorquinone | 1.5 |
| Total | 100 |

The following LED lamp with settings listed is used for concrete coating.
Model: Phoseon 75x50WC 395, RX FireFlex, water cooling LED, S/N: 585001
Speed: 27 ft/min
LED output: By EIT Power Puck, S/N: 2692. UVB=UVC=0. UVA=0.499 w/cm² and 0.136 J/cm². The measurement for UVV was saturation with current Power Puck UVV>5.000 w/cm² and >01.584 it cm².

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A radiation curable floor coating composition, wherein the composition is capable of undergoing photopolymerization when coated on the surface of a floor and when cured by irradiating with light emitted from a light emitting diode (LED) light having a wavelength from 100 nm to 900 nm, to provide a cured coating on the surface of the floor, said cured coating having a surface, said cured coating having a % Reacted Acrylate Unsaturation (% RAU) of about 60% or greater as measured at said surface, preferably from 90% to 99%.

2. The radiation curable floor coating composition of claim 1, wherein the light emitting diode (LED) emits light with a wavelength of
from 100 nm to 300 nm;
from 300 nm to 475 nm; or
from 475 nm to 900 nm.

3. The radiation curable floor coating composition of claim 1 comprising:
(a) at least one radiation curable oligomer selected from the group consisting of urethane (meth)acrylates, epoxy (meth)acrylates, polyester (meth)acrylates, acrylic (meth)acrylates, and hydrocarbon (meth)acrylates;
(b) at least one reactive diluent monomer; and
(c) at least one photomitiator.

4. The radiation curable floor coating composition of claim 3, wherein the photoinitiator is a Type I photoinitiator, preferably selected from the group consisting of 2-benzyl-2-(dimethylamino)-4′-morpholinobuiyrophenone,
bis(2,4,6˜trimethylbenzoyl)-phenylphosphineoxide, 2,4,6-trimethylbenzoyl diphenylphosphineoxide, 2-methyl-4′-(methylthio)-2-morpholinopropiophenone, and any combination thereof.

5. The radiation curable floor coating composition of claim 3, wherein the photoinitiator is a Type II photoinitiator and the composition includes a photosensitizer, the photoinitiator preferably being selected from the group consisting of 4-benzoyl-4′-methyl-diphenylsulflde and 2-isopropyl thioxanthone and any combination thereof.

6. The radiation curable floor coating composition of claim 1, in which at least 15% of the ingredients in the coating are bio-based, rather than petroleum based, preferably at least 20% of the ingredients, more preferably at least 25% of the ingredients.

7. The radiation curable floor coating composition of claim 1, wherein the at least one oligomer is a urethane acrylate oligomer;

8. A process for coating a floor comprising:
(a) selecting a floor to be coated;
(b) preparing the surface of said floor to be coated;
(c) coating said floor with at least one radiation curable coating composition for a floor, preferably a radiation curable floor coating composition according to claim 1, wherein said at least one radiation curable floor coating comprises:
(i) at least one radiation curable oligomer selected from the group consisting of urethane (meth)acrylates, epoxy (meth)acrylates, polyester (meth)acrylates, acrylic (meth)acrylates, and hydrocarbon (meth)acrylates;
(ii) at least one reactive diluent monomer; and
(iii) at least one photoinitiator;
to obtain a coated floor with an uncured coating, and
(d) curing said uncured coating on said coated glass optical fiber by irradiating said uncured coating with a light emitting diode (LED) light, having a wavelength from 100 nm to 900 nm, to obtain a cured coating having a surface, said cured coating having a % Reacted Acrylate Unsaturation (% RAU) at the surface of about 60% or greater, preferably from 90% to 99%.

9. Process according to claim 8, wherein said floor is selected from the group of concrete floors and wood floors.

10. The process of claim 8, wherein the wavelength of the light emitted from the LED that is used to cure the radiation curable coating is
from 100 nm to 300 nm;
from 300 nm to 475 nm; or
from 475 nm to 900 nm.

11. The process of claim 8, wherein the at least one oligomer is a urethane acrylate oligomer:

12. A coated floor obtainable by the process of claim 8.

13. The coated floor of claim 12, wherein the photoinitiator present in the radiation curable floor coating composition is a Type I photoinitiator, preferably selected from the group consisting of
2-benzyl-2-(dimethylammo)-4′-morpholinobutyrophenone, bis(2,4,6-trimethylbenzoyl)-phenylphosphineoxide, 2,4,6-trimethylbenzoyl diphenylphosphineoxide, 2-methyl-4′-(methylthio)-2-morpholinopropiophenone, and any combination thereof.

14. The coated floor of claim 12, wherein the photoinitiator is a Type II photoinitiator and the composition includes a photosensitizer, the photoinitiator preferably being selected from the group consisting of 4-benzoyl-4′-methyl-diphenylsulfide and 2-isopropyl thioxanthone and any combination thereof.
